(19) United States
(12) Patent Application Publication
(10) Pub. No.: US 2004/0216995 A1
(43) Pub. Date: Nov. 4, 2004

(54) Nickel-iron anodes for aluminium electrowinning cells

(76) Inventors: Thinh T Nguyen, Onex (CH); Vittorio De Nora, Nassau (BS)

Correspondence Address: Jay R Deshmukh, 6 Meetinghouse Ct, Princeton, NJ, 08540, US

(21) Appl. No.: 10/474,764

(22) PCT Filed: Apr. 10, 2002
(86) PCT No.: PCT/IB02/01241

(51) Int. Cl. B01D 59/40; B01D 1/00; C25B 11/04; C25C 3/06; C25C 3/08; C25C 3/12

(52) U.S. Cl. 204/243.1; 204/292; 204/293; 205/372; 205/384; 205/385

(57) ABSTRACT

An anode of a cell for the electrowinning of aluminium has a nickel-iron alloy outer portion which during use is covered with an integral iron-based oxide surface layer. The nickel-iron alloy outer portion comprises one or more rare earth metals that are substantially insoluble in nickel and iron. These rare earth metals are present in the outer portion in an amount which provides during use controlled diffusion of iron from the outer portion to the integral iron-based oxide surface layer. This controlled diffusion of iron is on the one hand sufficiently high to compensate dissolution of iron oxide from the integral iron-based oxide surface layer into the electrolyte thereby avoiding passivation of the anode by oxidation and/or fluorination of nickel of the outer portion which is not protected by iron oxide, and on the other hand sufficiently low to limit the thickness of the integral iron-based oxide surface layer and maintain its coherence and electrolyte imperviousness thereby avoiding internal corrosion of the integral iron-based oxide surface layer by electrolytic dissolution.

### FIELD OF THE INVENTION

This invention relates to non-carbon, nickel-iron based anodes for use in cells for the electrowinning of aluminium from alumina dissolved in a fluoride-containing molten electrolyte, electrowinning cells containing such anodes and their use to produce aluminium.

### BACKGROUND ART

The technology for the production of aluminium by the electrolysis of alumina, dissolved in molten cryolite, at temperatures around 950° C. is more than one hundred years old. This process, conceived almost simultaneously by Hall and Héroult, has not evolved as many other electrochemical processes.

The anodes are still made of carbonaceous material and must be replaced every few weeks. During electrolysis the oxygen which should evolve on the anode surface combines with the carbon to form polluting CO₂ and small amounts of CO and fluorine-containing dangerous gases. The actual consumption of the anode is as much as 450 Kg/Ton of aluminium produced which is more than ⅓ higher than the theoretical amount of 333 Kg/Ton.

Using metal anodes in aluminium electrowinning cells would drastically improve the aluminium process by reducing pollution and the cost of aluminium production.

U.S. Pat. No. 4,374,050 (Ray) discloses inert anodes made of specific multiple metal compounds which are produced by mixing powders of the metals or their compounds in given ratios followed by pressing and sintering, or alternatively by plasma spraying the powders onto an anode substrate. The possibility of obtaining the specific metal compounds from an alloy containing the metals is mentioned.

U.S. Pat. Nos. 4,614,569 (Duruz/Derivaz/Debely/Adorian), 4,680,094 (Duruz), 4,683,037 (Duruz) and 4,966,674 (Bannochie/Sherriff) describe non-carbon anodes for aluminium electrowinning coated with a protective coating of cerium oxyfluoride, formed in-situ in the cell or pre-applied, this coating being maintained by the addition of a cerium compound to the molten cryolite electrolyte. This made it possible to have a protection of the surface from the electrolyte attack and to a certain extent from the gaseous oxygen but not from the nascent monoatomic oxygen.

EP Patent application 0 306 100 (Nyguen/Lazouni/Doan) describes anodes composed of a chromium, nickel, cobalt and/or iron based substrate covered with an oxygen barrier layer and a ceramic coating of nickel, copper and/or manganese oxide which may be further covered with an in-situ formed protective cerium oxyfluoride layer. Likewise, U.S. Pat. Nos. 5,069,771, 4,960,494 and 4,956,068 (all Nyguen/Lazouni/Doan) disclose aluminium production anodes with an oxidised copper-nickel surface on an alloy substrate with a protective oxygen barrier layer. However, full protection of the alloy substrate was difficult to achieve.

U.S. Pat. No. 5,510,008 (Sekhar/Liu/Duruz) discloses an anode made from an inhomogeneous porous metallic body obtained by micropyretically reacting a powder mixture of 50-90 wt % nickel, 5-20 wt % iron, 3-20 wt % aluminium, 0-15 weight % copper and 0-5 wt % chromium, manganese, titanium, molybdenum, cobalt, zirconium, niobium, tantalum, yttrium, cerium, oxygen, boron and nitrogen.

WO00/06803 (Duruz/de Nora/Crottaz) and WO00/06804 (Crottaz/Duruz) disclose an anode produced from a nickel-iron alloy which is surface oxidised to form a coherent and adherent outer iron oxide-based layer whose surface is electrochemically active. It is mentioned that the nickel-iron alloy can comprise one or more additional alloying metals selected from titanium, copper, molybdenum, aluminium, hafnium, manganese, niobium, silicon, tantalum, tungsten, vanadium, yttrium and zirconium, in a total amount of up to 5 weight %. WO01/42534 (de Nora/Duruz), WO01/42535 (Duruz/de Nora) and WO01/42536 (Duruz/Nguyen/de Nora) disclose further nickel-iron alloy anodes for aluminium electrowinning.

WO00/06805 (de Nora/Duruz) discloses an aluminium electrowinning anode having a metallic anode body which can be made of various alloys, for example a nickel-iron-copper alloy. It is inter-alia mentioned that the anode body may contain one or more additives selected from beryllium, magnesium, yttrium, titanium, zirconium, vanadium, niobium, tantalum, chromium, molybdenum, tungsten, manganese, rhodium, silver, aluminium, silicon, tin, hafnium, lithium, cerium and other Lanthanides. During use, the surface of the anode body is oxidised by anodically evolved oxygen to form an integral electrochemically active oxide-based surface layer. The oxidation rate of the anode body is substantially equal to the rate of dissolution of the surface layer into the electrolyte. This oxidation rate is controlled by the thickness and permeability of the surface layer which limits the diffusion of anodically evolved oxygen therethrough to the anode body and by the operating temperature of the electrolyte.

Metal or metal-based anodes are highly desirable in aluminium electrowinning cells instead of carbon-based anodes. Many attempts were made to use metallic anodes for aluminium production, however they were never adopted by the aluminium industry for commercial aluminium production because their lifetime must still be increased.

### SUMMARY OF THE INVENTION

The invention relates to an anode of a cell for the electrowinning of aluminium from alumina dissolved in a fluoride-containing molten electrolyte. The anode has a nickel-iron alloy outer portion which during use is covered with an integral iron-based oxide surface layer. The nickel-iron alloy outer portion comprises one or more rare earth metals that are substantially insoluble in nickel and iron. These rare earth metals are present in the outer portion in an amount which provides during use controlled diffusion of iron from the outer portion to the integral iron-based oxide surface layer. This amount of rare earth metal(s) provides controlled diffusion of iron which is on the one hand sufficiently high to compensate dissolution of iron oxide from the integral iron-based oxide surface layer into the electrolyte thereby avoiding passivation of the anode by oxidation and/or fluorination of nickel of the outer portion which is not protected by iron oxide, and on the other hand sufficiently low to limit the thickness of the integral iron-based oxide surface layer and maintain its coherence and electrolyte imperviousness thereby avoiding internal corrosion of the integral iron-based oxide surface layer by electrolytic dissolution.

The invention is based on the observation that iron diffusion from a nickel-iron alloy can be controlled and limited by adding to the nickel-iron alloy composition a suitable amount of a rare earth metal which is substantially insoluble with nickel and iron.

In other words, the diffusion rate of iron from the nickel-iron alloy of the anode can be reduced by adding a suitable rare earth metal to the alloy. Thus, when the diffusion rate of iron is too high under specific conditions, an addition of an adjusted amount of suitable rare earth metals to the nickel-iron alloy reduces the diffusion of iron to an adjusted diffusion rate which prevents passivation of the anode or corrosion of the anode's integral iron-based oxide surface layer during use.

When a nickel-iron alloy is cast, the presence of the above rare earth metal refines the structure of the alloy by reducing the grain size, for example from about 0.5-1 cm to about 50-100 micron when yttrium is used as an additive.

Such a rare earth metal migrates predominantly to the grain boundaries of the nickel-iron alloy and acts as a barrier against diffusion of iron from the grain. At the grain boundaries, the rare earth metals can be present before oxidation as a substantially distinct metal phase, for instance in an intermetallic compound with nickel, and after oxidation as oxides, in particular mixed oxides with nickel and/or iron. To be effective, oxidation of the rare earth metal should be avoided before it has reached the grain boundaries.

In contrast to the teaching of WO00/06805 mentioned above, the oxidation of the anode is limited by the diffusion of iron from the nickel-iron alloy towards the oxide surface layer which diffusion is controlled by the presence of an adjusted amount of rare earth metals present in the anode. By adjusting the amount of the rare earth metals in the alloy, the ability of iron to diffuse to the surface of the anode can thus be precisely controlled and adjusted to the specific composition of the nickel-iron alloy of the anode and circumstances of use.

Besides the amount of rare earth metals, the parameters that have an impact on the diffusion of iron from the nickel-iron alloy during use include the iron-content and composition of the alloy, the intended temperature of use of the anode and composition of the electrolyte.

The intended use temperature of the anode has a predominant impact on the diffusion of iron from the nickel-iron alloy. It is possible in practice to adjust the amount of rare earth metal(s) in the alloy only in accordance with the intended temperature of use. Variations in the bath composition or alloy composition can be ignored when the bath is a cryolite-based melt and the alloy of the anode has an iron-content in the range of about 30 to 80 weight %.

Indeed, an increase of 100° C. of the temperature of use multiplies the diffusion rate of iron from the nickel-iron alloy of the anode by a factor of about 10 to 100.

Conversely, a variation in the bath composition has only a small impact on the dissolution rate of iron oxide from the anode's integral iron-based oxide surface layer. Also, when the concentration of iron in the alloy is changed, the variation of diffusion of iron is of the same order as the change of concentration.

In any case, the effective amount of rare earth metals in the alloy is small and is confined within a small range at given conditions in order to meet up to the requirements of minimal and maximal diffusion of iron from the alloy to prevent passivation of the anode and internal corrosion of the anode's integral iron-based oxide surface layer in accordance with the invention.

For example, when the rare earth metal is yttrium, 4 weight % of yttrium in the alloy prevents diffusion of iron even at high temperature of use and therefore a smaller amount of yttrium is needed to permit diffusion. On the other hand an amount of yttrium below 0.75 weight % does not sufficiently limit diffusion of iron even at low temperature of use and therefore a greater amount of yttrium is needed to appropriately limit diffusion of iron. For a given temperature of use, the suitable amount of yttrium needed to avoid passivation and corrosion is confined within a range having a span of 1 or 1.5 weight % of the alloy. For instance, for use at about 900°-930° C. the suitable amount of yttrium is in the range from 0.75 to 2.25 weight %, preferably from 1 to 1.75 or 2 weight %, of the alloy.

Suitable rare earth metals include Actinides, such as scandium or yttrium, and Lanthanides, such as cerium and ytterbium.

Suitable amounts of the rare earth metals, in particular the Actinides and the Lanthanides, are substantially the same as the above described yttrium amounts. Likewise, when a combination of rare earth metals is used in the alloy the total amount of the combination should be about equivalent the above described yttrium amounts.

As mentioned above, the rare earth metal(s) may form an intermetallic compound with nickel and/or may be present as oxides, in particular a mixed oxide with iron and/or nickel. The rare earth metals are usually present at the grain boundaries of the nickel-iron alloy of the outer portion. However, if the nickel-iron alloy is quenched after casting then the rare earth metal is distributed throughout the alloy and migrates to the grain boundaries where it is effective only when the alloy is subjected to heat treatment (tempering).

The nickel-iron alloy outer portion can have an iron/nickel weight ratio in the range of 1 to 3.

The nickel-iron alloy outer portion may have an openly porous nickel rich outer part which consists predominantly of nickel metal and which is obtainable by removal of at least part of the iron from the nickel-iron alloy. Usually, the pores are partly or completely filled with iron and nickel compounds.

Upon oxidation before and/or during use, the nickel-iron alloy outer portion is covered with an integral iron-based oxide layer that comprises oxides of iron, nickel and of the rare earth metal(s) and possibly oxides of oxidisable additives which can be present in the nickel-iron alloy as described out below.

After pre-oxidation and at the beginning of use, the nickel-iron alloy outer portion usually comprises a non-porous inner part.

The nickel-iron alloy outer portion of the anode may further comprise aluminium and/or titanium which contribute(s) to reduce diffusion of iron during use. The nickel-iron alloy outer portion may have a weight ratio of the rare earth metal(s)/aluminium and/or titanium of at least 2.

The nickel-iron alloy outer portion may consist essentially of iron, nickel, the rare earth metal(s) and optionally aluminium and/or titanium. In some embodiments, the nickel-iron alloy comprises nickel, iron, the rare earth metal(s) and possibly aluminium and/or titanium in a total amount of at least 85 weight %, preferably at least 90 or 95 weight % of the alloy. For example, the nickel-iron alloy outer portion comprises at least one further metal selected from chromium, copper, silicon, tantalum, tungsten, vanadium, zirconium, molybdenum, manganese and niobium in a total amount of up to 5 or 10 weight % of the alloy. Furthermore, the nickel-iron alloy outer portion may comprise at least one catalyst selected from iridium, palladium, platinum, rhodium, ruthenium, tin or zinc metals, Mischmetals and their oxides and metals of the Lanthanide series and their oxides as well as mixtures and compounds thereof, in a total amount of up to 5 weight % of the alloy.

The anode may comprise a core made of an electronically conductive material, such as metals, in particular nickel, alloys, intermetallics, cermets and conductive ceramics, which is covered with the nickel-iron alloy outer portion. Suitable materials which can be used as an anode core are described in WO00/06805 (de Nora/Duruz).

The lifetime of the anode according to the invention can be extended by using a surface coating made of one or more cerium compounds, such as cerium oxyfluoride, on the outer portion which can be maintained during use by adding cerium species to the electrolyte, for example as disclosed in the above mentioned U.S. Pat. Nos. 4,614,569, 4,680,094, 4,683,037 and 4,966,674.

In a modification of the invention, the nickel of the nickel-iron alloy outer portion of the anode is wholly or predominantly substituted by cobalt.

The invention also relates to a cell for the electrowinning of aluminium from alumina dissolved in a fluoride-containing molten electrolyte. The cell comprises at least one of the above described anodes facing and spaced from at least one cathode.

Another aspect of the invention relates to a method of producing aluminium in such a cell which contains alumina dissolved in a molten electrolyte. The method comprises passing an ionic current in the molten electrolyte between the cathode(s) and the anode(s), thereby evolving oxygen gas derived from the dissolved alumina at the anode(s) and producing aluminium on the cathode(s).

To inhibit dissolution of the anode(s), the molten electrolyte may be permanently and uniformly substantially saturated with alumina and species of at least one major metal, e.g. iron, present in the nickel-rich alloy outer portion of the anode(s), as disclosed in WO00/06802 (Duruz/de Nora/Crottaz). Furthermore, the cell may be operated with the molten electrolyte at a temperature sufficiently low, e.g. from 830° to 930° C., to limit the solubility of said major metal species thereby limiting the contamination of the product aluminium to an acceptable level. As mentioned above, operation at low temperature also reduces the diffusion of iron from the nickel-iron alloy of the anode which thus requires less rare earth metal(s).

Aluminium may be produced on an aluminium-wettable cathode, in particular a drained cathode, for instance as disclosed in WO99/02764, WO99/41429 (both de Nora/Duruz), WO00/63463 (de Nora), WO01/31086 (de Nora/Duruz) and WO01/31088 (de Nora). Aluminium-wettable cathode materials are disclosed in WO01/42168 (de Nora/Duruz) and WO01/42531 (Nguyen/Duruz/de Nora).

A further aspect of the invention relates to the use, in a nickel-iron alloy outer portion of an anode for the electrowinning of aluminium for alumina dissolved in a fluoride-containing molten electrolyte, of a rare earth metal which is substantially insoluble with nickel and iron as a diffusion controller of iron from the nickel-iron alloy outer portion at high temperature. The rare earth metal is used in an amount that limits diffusion of iron from the nickel-iron alloy without preventing such diffusion.

Yet another aspect of the invention relates to a method for controlling diffusion at high temperature of iron from a nickel-iron alloy outer portion of an anode for the electrowinning of aluminium from alumina dissolved in a fluoride-based molten electrolyte. The method comprises the step of providing in the nickel-iron alloy outer portion a rare earth metal which is substantially insoluble with nickel and iron. The rare earth metal is provided in an amount that limits diffusion of iron from the nickel-iron alloy without preventing such diffusion at high temperature.

The use and the method of the invention are applicable with any of the above described anode features or combination of features.

### DETAILED DESCRIPTION

The invention will be further described in the following Examples:

### EXAMPLE 1

### Anode Preparation and Examination

An anode according to the invention was made of a nickel-iron alloy which consisted of 50 weight % nickel, 0.3 weight % manganese, 0.5 weight silicon and 1.7 weight % yttrium, the balance being iron, which was pre-oxidised in air at a temperature of 1100° C. for 3 hours.

The pre-oxidised anode was cut perpendicularly to the anode operative surface and the resulting section of the anode before use was subjected to microscopic examination.

It was observed that the anode had an outer portion comprising an integral nickel-iron oxide surface layer having an outer part consisting essentially of iron oxide (95-97 weight %) having a thickness of about 70 micron and an inner part made of iron oxide and nickel oxide with an Fe/Ni ratio of about 4 having a thickness of about 80 micron.

Underneath the integral oxide surface layer, the outer part of the anode was made of a cermet of a nickel-iron alloy with small inclusion of iron oxide (less than 10%) having a diameter smaller than 10 micron. This cermet part had a thickness of about 150 micron. The nickel-iron alloy of the cermet was made of grains consisting of nickel and iron metal having at its grain boundaries mixed oxides of nickel, iron and yttrium.

Underneath the cermet part, the outer portion of the anode had a part that remained un-oxidised and was made of nickel-iron grains with intermetallics of yttrium and nickel at the grain boundaries.

### Anode Testing and Examination

An anode as prepared above was immersed in an electrolyte of a laboratory scale cell containing a molten electrolyte at 915° C. consisting of about 20 weight % AlF₃, 5.5 weight % alumina and 2 to 4 weight % CaF₂, the balance being cryolite (Na₃AlF₆). The alumina concentration was maintained at a substantially constant level throughout the test by adding alumina at a rate adjusted to compensate the cathodic aluminium reduction. The test was run at a current density of about 0.8 A/cm², and the electrical potential of the anode remained substantially constant at 4.2 volts throughout the test.

During electrolysis aluminium was cathodically produced while oxygen was anodically evolved which was derived from the dissolved alumina present near the anodes.

After 72 hours, electrolysis was interrupted and the anode was extracted from the cell. The external dimensions of the anode had remained unchanged during the test and the anode showed no signs of damage.

The used anode was cut perpendicularly to the anode operative surface and the resulting section of the used anode was subjected to microscopic examination.

It was observed that an integral outer layer of about 300 to 400 micron of iron oxide had formed on the anode. Mixed oxides of yttrium, nickel and iron had formed at the grain joints. Some small inclusions of iron oxide were also found in the nickel-iron alloy underlying the outer layer.

The absence of any corrosion demonstrated that the pores and/or cracks in the electrolyte-pervious electrochemically active oxide layer were sufficiently small that, when polarised during use, the voltage drop through the pores and/or cracks was below the potential of electrolytic dissolution of the oxide of the surface layer.

Underneath the outer portion, the nickel-iron alloy had remained unchanged.

The shape and external dimensions of the anode had remained unchanged after electrolysis which demonstrated stability of this anode structure under the operating conditions in the molten electrolyte.

### EXAMPLE 2 (COMPARATIVE)

Example 1 was repeated with a comparative anode produced by pre-oxidising an yttrium-free nickel-iron alloy which consisted of 50 weight % nickel, 0.3 weight % manganese and 0.5 weight silicon, the balance being iron. Pre-oxidation was carried out in air at a temperature of 1100° C. for 3 hours.

After 72 hours electrolysis under the conditions of Example 1, the comparative anode was extracted from the electrolyte and cut perpendicularly to the anode operative surface and the resulting section of the used anode was subjected to microscopic examination.

It was observed that an outer layer of about 1 to 2 mm of iron oxide had accumulated at the surface of the anode. Such an accumulation of oxide affects the quality of the electrochemically active surface of the anode.

The diffusion of iron during use was about 10 times faster than with the anode of Example 1. This demonstrated the effect of yttrium for reducing diffusion of iron from nickel-iron alloy.

Thus, an anode made of a nickel-iron alloy containing a small amount of a rare earth metal, such as yttrium, reduces diffusion of iron to the surface of the electrolyte, permits operation with an electrochemically active surface of better quality and longer lifetime.

### EXAMPLE 3 (COMPARATIVE)

Another comparative anode was made of a pre-oxidised yttrium-rich nickel-iron alloy which consisted of 50 weight % nickel, 0.3 weight % manganese, 0.5 weight silicon, 0.3 weight % aluminium and 4 weight % yttrium, the balance being iron. Pre-oxidation was carried out in air at a temperature of 1100° C. for 3 hours.

The comparative anode was tested under the same conditions as in Example 1.

After 22 hours, the cell voltage increased exponentially above 10 volt and substantially no electrolysis current passed at the anode due to its passivation. Electrolysis was interrupted and the anode was extracted from the cell. The external dimensions of the anode had remained unchanged during the test and the anode showed no signs of damage.

The anode was cut perpendicularly to the anode operative surface and the resulting section of the used anode was subjected to microscopic examination, as in Example 1.

It was observed that a thin insulating layer of nickel fluoride had formed at the surface of the anode which resulted from the passivation of the anode.

### EXAMPLE 4 (COMPARATIVE)

An anode made of a surface oxidised nickel iron alloy consisting of 50 weight % nickel, 0.3 weight % manganese, 0.5 weight silicon, 0.3 weight % aluminium and 0.5 weight % yttrium, the balance being iron, was also tested as in Example 2.

Iron diffusion from the anode's outer portions was less than that observed in Example 2, but the integral iron-based oxide layer was not coherent and uniform and showed signs of corrosion, indicating that the diffusion was still to high.

This indicates that in these conditions more than 0.5 weight % yttrium is needed in the nickel-iron alloy.

1. An anode of a cell for the electrowinning of aluminium from alumina dissolved in a fluoride-containing molten electrolyte, said anode having a nickel-iron alloy outer portion which during use is covered with an integral iron-oxide based surface layer, the nickel-iron alloy outer portion comprising one or more rare earth metals that are substantially insoluble in nickel and iron and are present in an amount which provides during use controlled diffusion of iron from the outer portion to the integral iron-based oxide surface layer, said amount of rare earth metals providing controlled diffusion of iron which is (a) sufficiently high to compensate dissolution of iron oxide from the integral iron-based oxide surface layer into the electrolyte thereby avoiding passivation of the anode by oxidation and/or fluorination of nickel of the outer portion which is not protected by iron oxide; and (b) sufficiently low to limit the thickness of the integral iron-based oxide surface layer and maintain its coherence and electrolyte imperviousness thereby avoiding internal corrosion of the integral iron-based oxide surface layer by electrolytic dissolution.

2. The anode of claim 1, wherein the or at least one rare earth metal is an Actinide, such as scandium or yttrium.

3. The anode of claim 1, wherein the or at least one rare earth metal is a Lanthanide, such as cerium or ytterbium.

4. The anode of claim 1, 2 or 3, wherein the or at least one rare earth metal forms an intermetallic compound with nickel.

5. The anode of any preceding claim, wherein the or at least one rare earth metal is present as an oxide, in particular a mixed oxide with iron and/or nickel.

6. The anode of any preceding claim, wherein the or at least one rare earth metal is present at grain boundaries of the nickel-iron alloy of the outer portion.

7. The anode of any preceding claim, wherein the nickel-iron alloy outer portion comprises at least 50 weight % iron.

8. The anode claim 7, wherein the nickel-iron alloy outer portion has an iron/nickel weight ratio in the range of 1 to 3.

9. The anode of any preceding claim, wherein the nickel-iron alloy outer portion has an openly porous nickel rich outer part which consists predominantly of nickel metal and which is obtainable by removal of at least part of the iron from the nickel-iron alloy.

10. The anode of claim 9, wherein the nickel rich openly porous outer part contains pores which are partly or completely filled with iron and nickel compounds.

11. The anode of any preceding claim, wherein the nickel-iron alloy outer portion is covered with said integral iron-based oxide layer comprising oxides of iron, nickel and of the rare earth metal(s).

12. The anode of any preceding claim, wherein the nickel-iron alloy outer portion comprises a non-porous inner part.

13. The anode of any preceding claim, wherein the nickel-iron alloy outer portion further comprises aluminium and/or titanium.

14. The anode of claim 13, wherein the nickel-iron alloy outer portion has a weight ratio of the rare earth metal(s)/aluminium and/or titanium of at least 2.

15. The anode of claim 13 or 14, wherein the nickel-iron alloy outer portion consists essentially of iron, nickel, the rare earth metal(s) and optionally aluminium and/or titanium.

16. The anode of any one of claims 1 to 14, wherein the nickel-iron alloy outer portion comprises nickel, iron, the rare earth metal(s) and optionally aluminium and/or titanium in a total amount of at least 85 weight %, preferably at least 90 weight % of the alloy.

17. The anode of claim 16, wherein the nickel-iron alloy outer portion comprises at least one further metal selected from chromium, copper, silicon, tantalum, tungsten, vanadium, zirconium, molybdenum, manganese and niobium in a total amount of up to 10 weight % of the alloy.

18. The anode of claim 16 or 17, wherein the nickel-iron alloy outer portion comprises at least one catalyst selected from iridium, palladium, platinum, rhodium, ruthenium or zinc metals, Mischmetals and their oxides and metals of the Lanthanide series and their oxides as well as mixtures and compounds thereof, in a total amount of up to 5 weight % of the alloy.

19. The anode of any preceding claim, comprising a core made of an electronically conductive material, such as metals, alloys, intermetallics, cermets and conductive ceramics, which is covered with the nickel-iron alloy outer portion.

20. The anode of any preceding claim, which comprises a surface coating made of one or more cerium compounds, such as cerium oxyfluoride.

21. The anode of any preceding claim modified in that the nickel of the nickel-iron alloy outer portion is wholly or predominantly substituted by cobalt.

22. A cell for the electrowinning of aluminium from alumina dissolved in a fluoride-containing molten electrolyte, the cell comprising at least one anode as defined in any preceding claims facing and spaced from at least one cathode.

23. A method of producing aluminium in a cell according to claim 22 containing alumina dissolved in a molten electrolyte, the method comprising passing an ionic current in the molten electrolyte between the cathode(s) and the anode(s), thereby evolving oxygen gas derived from the dissolved alumina at the anode(s) and producing aluminium on the cathode(s).

24. The method of claim 23, comprising permanently and uniformly substantially saturating the molten electrolyte with alumina and species of at least one major metal present in the nickel-rich alloy outer portion of the anode(s) to inhibit dissolution of the anode(s).

25. The method of claim 24, wherein the cell is operated with the molten electrolyte at a temperature sufficiently low to limit the solubility of said major metal species thereby limiting the contamination of the product aluminium to an acceptable level.

26. The method of any one of claims 23 to 25, wherein the cell is operated with the molten electrolyte at a temperature from 830° to 930° C.

27. The method of any one of claims 23 to 26, wherein aluminium is produced on an aluminium-wettable cathode, in particular a drained cathode.

28. Use, in a nickel-iron alloy outer portion of an anode for the electrowinning of aluminium for alumina dissolved in a fluoride-containing molten electrolyte, of a rare earth metal which is substantially insoluble with nickel and iron as a diffusion controller of iron from the nickel-iron alloy outer portion at high temperature, said rare earth metal being used in an amount that limits diffusion of iron from the nickel-iron alloy without preventing such diffusion.

29. The use of claim 28, wherein the or at least one rare earth metal forms an intermetallic compound with nickel.

30. The use of claim 28 or 29, wherein the or at least one rare earth metal is present as an oxide, in particular a mixed oxide with iron and/or nickel.

31. A method for controlling diffusion at high temperature of iron from a nickel-iron alloy outer portion of an anode for the electrowinning of aluminium from alumina dissolved in a fluoride-based molten electrolyte, said method comprising the step of providing in the nickel-iron alloy outer portion a rare earth metal which is substantially insoluble with nickel and iron, said rare earth metal being provided in an amount that limits diffusion of iron from the nickel-iron alloy without preventing such diffusion at high temperature.
